(19) United States
(12) Patent Application Publication
(10) Pub. No.: US 2021/0231766 A1
(43) Pub. Date: Jul. 29, 2021

(54) METHOD AND SYSTEM FOR SENSING A POSITION OF A MOBILE TERMINAL RELATIVE TO A VEHICLE

(71) Applicants: Volkswagen Aktiengesellschaft, Wolfsburg (DE); HELLA GMBH & CO. KGAA, Lippstadt (DE)

(72) Inventors: Claus-Peter BRUECKNER, Braunschweig (DE); Bernd ETTE, Wolfsburg (DE); Ludger WEGHAUS, Lippstadt (DE); Roman CURKIN, Lippstadt (DE)

(21) Appl. No.: 16/313,559

(22) PCT Filed: Jun. 27, 2017
(86) PCT No.: PCT/EP17/65801

§ 371 Date: Dec. 27, 2018

(30) Foreign Application Priority Data
Jun. 27, 2016 (DE) 10 2016 111 706.4

(51) Int. Cl. G01S 5/02; G01S 19/45; G01S 5/18; B60R 25/24; B60R 25/045; B60R 25/31; B60R 25/32; B60R 25/10

(52) U.S. Cl. CPC G01S 5/0284; G01S 5/0264; G01S 19/45; G01S 5/18; B60R 25/1004; B60R 25/045; B60R 25/31; B60R 25/32; B60R 25/24

(57) ABSTRACT

The invention relates to a method for detecting a relative position of a mobile terminal device with respect to a vehicle.

It is provided for the method to include the following steps: Providing several evaluation signals which are changeable by a change of position of the mobile terminal device, determining an event at the vehicle and evaluating the several provided evaluation signals for detecting the relative position of the mobile terminal device with respect to the vehicle in response to determining the event at the vehicle.

The invention is based on the object of detecting the relative position of a mobile terminal device with respect to a vehicle with a higher accuracy so that it may be determined reliably whether the mobile terminal device has been left back in the vehicle when leaving the vehicle, whether the mobile terminal device is located within the vehicle after a person has entered the vehicle, and/or whether the mobile terminal device is located within the vehicle when the vehicle starts driving or when the motor of the vehicle is started.

The invention relates to a method for detecting a relative position of a mobile terminal device with respect to a vehicle and a system for detecting a relative position of a mobile terminal device with respect to a vehicle.

With modern vehicles, mobile terminal devices, like e.g. smartphones, may already be used to lock or unlock vehicle doors. Like when using conventional car keys, also when using mobile terminal devices there is a risk that the mobile terminal device is located within the vehicle due to unattentiveness of the user during locking the vehicle by means of another device and is thus locked in.

Already, passive vehicle access systems are known which detect the position of a mobile terminal device to monitor whether the mobile terminal device is still located within the vehicle when the user starts the locking process.

If a passive vehicle access system realizes that the mobile terminal device has been forgotten in the vehicle, measures are initiated which prevent that the mobile terminal device is locked in. For example, it may be indicated to the user by an acoustic or optical signal during the locking attempt that the mobile terminal device is still located within the vehicle. Additionally, locking may be interrupted.

For an implementation of the described function it is necessary to detect the relative position of a mobile terminal device with respect to a vehicle.

Reference DE 10 2004 024 890 A1 proposes a device for detecting the position of an object in space, wherein a magnetic field modulator module generates a temporally and spatially varying magnetic field which is detected by a sensor module. The measurement signal generated by the sensor module is evaluated by an evaluation unit for determining the position of the object in space.

The document DE 10 2009 038 580 A1 discloses a method for detecting a mobile device left back in a vehicle wherein between the mobile device and the vehicle a signal is transmitted via radio. In order to detect whether the mobile device has been left back in the vehicle, the field strength of the signal is detected and evaluated when a passenger gets out of the vehicle.

Further, in Reference DE 10 2012 212 612 A1 a method for determining the whereabouts of a user with reference to a vehicle is known, wherein the user has a mobile terminal device with him. Detecting the user getting in and/or out of the vehicle may be based on data by sensors of the mobile terminal device and/or data by sensors of the vehicle.

Prior solutions are not suitable, however, to determine the relative position of a mobile terminal device with respect to a vehicle sufficiently precisely. A reliable determination as to whether a mobile terminal device has been left back in the vehicle when leaving the vehicle may thus not be made.

The invention is now based on the object of detecting the relative position of a mobile terminal device with respect to a vehicle with a higher accuracy so that it may be determined reliably whether the mobile terminal device has been left back in the vehicle when leaving the vehicle, whether the mobile terminal device is located within the vehicle after a person has entered the vehicle, and/or whether the mobile terminal device is located within the vehicle when the vehicle starts driving or when the motor of the vehicle is started.

This object is solved by a method according to claim 1 and/or a system according to claim 15.

According to a first aspect, embodiments provide a method for detecting a relative position of a mobile terminal device with respect to a vehicle. The method includes providing several evaluation signals. The evaluation signals are changed by a change of position of the mobile terminal device. Further, the method includes determining an event at the vehicle. The method further comprises evaluating the several provided evaluation signals for detecting the relative position of the mobile terminal device with respect to the vehicle in response to determining the event at the vehicle.

The inventive method has the advantage that the position determination and/or the location of the mobile terminal device is not only based on an evaluation signal and thus does not depend on the accuracy of the one evaluation signal. By providing an evaluating several evaluation signals changeable by a change of position of the mobile terminal device, the relative position of the mobile terminal device with respect to the vehicle may consequently be detected with a higher accuracy. This allows a reliable determination whether a mobile terminal device has been left back in the vehicle when leaving the vehicle.

As evaluating the several provided evaluation signals may be executed in response to determining the event at the vehicle, further a continuous detecting of the relative position of the mobile terminal device with respect to the vehicle may be omitted. By this, a continuous monitoring of the relative position of the mobile terminal may be prevented whereby data protection when executing the method may be increased. By this, further a user acceptance of the method may be increased. Further, as evaluating the several provided evaluation signals is executed with response to determining the event at the vehicle, the method may be executed more energy-efficiently as a required computing power, for example of a processor, for evaluating the several provided evaluation signals is not requested continuously but only with response to detecting the event.

The several evaluation signals may be provided by the mobile terminal device and/or by the vehicle. Further, the several evaluation signals may be provided on the basis of several sensor signals of one single sensor of the mobile terminal device or the vehicle. Alternatively or additionally, the several evaluation signals may also be provided on the basis of sensor signals of several sensors of the mobile terminal device and/or the vehicle. For example, at least one evaluation signal of the mobile terminal device and at least one further evaluation signal are provided by the vehicle or all evaluation signals are provided by the mobile terminal device or the vehicle. The evaluation signals may each include or represent information changed by the change of position of the mobile terminal device.

Further, providing the several evaluation signals may include the emission of at least one evaluation signal by the mobile terminal device to the vehicle via a wireless communication network and/or an emission of at least one evaluation signal from the vehicle to the mobile terminal device via the wireless communication network. The wireless communication network may be a bluetooth communication network, a bluetooth-low-energy communication network, a near field communication network, a Wireless Local Area Network (WLAN) communication network, an ultra wideband (UWB) radio connection or a mobile radio network. Further, the mobile terminal device and the vehicle may each comprise a wireless communication interface configured to communicate via the wireless communication network. The inventive method may further include emitting a request for providing the evaluation signals via the wireless communication network by the mobile terminal device and/or the vehicle. Additionally, the several evaluation signals may be provided in response to receiving the request by the mobile terminal device and/or the vehicle. For example, the request is emitted in response to determining the event.

Evaluating the several provided evaluation signals may be done by the vehicle and/or the mobile terminal device. In this respect, the vehicle and/or the mobile terminal device may comprise a processor or a controller configured for evaluating the several provided evaluation signals. For example, the processor is a central processing unit (CPU) of an on-board computer of the vehicle or the processor is a CPU of the mobile terminal device. Preferably, evaluating the several provided evaluation signals is done by the vehicle.

The relative position of the mobile terminal device with respect to the vehicle may indicate whether the mobile terminal device is located within an interior of the vehicle or outside the vehicle. For example, the interior of the vehicle is a passenger compartment of the vehicle and indicates the relative position, whether the mobile terminal device is located within the passenger compartment of the vehicle or outside the passenger compartment of the vehicle. Further, the relative position of the mobile terminal device with respect to the vehicle may include coordinates of the mobile terminal device in a coordinate system defined by the vehicle, for example a cartesian coordinate system. For example, the coordinate system is defined by elected points of a frame of the vehicle.

The method may further include indicating a note regarding the detected relative position of the mobile terminal device with respect to the vehicle. For indicating the note, the mobile terminal device and/or the vehicle may include an optical display device, like e.g. a monitor or a Light Emitting Diode (LED), an acoustic signaler, like e.g. a loudspeaker and/or a vibration alarm. For example, the note is indicated when the mobile terminal device is located within the vehicle after leaving or when leaving the vehicle, or the note is indicated when the mobile terminal device is located outside the vehicle, for example on a roof of the vehicle or on a windshield of the vehicle when starting the motor of the vehicle.

The event at the vehicle may be one of the following events: opening of closing a door, a flap, a window or another opening of the vehicle, operating a locking device of the vehicle, operating an ignition lock of the vehicle or operating a starter device of the vehicle. The event may be detected by means of the on-board computer of the vehicle. In this respect, the on-board computer may be connected in a signal conducting way to a door lock of the door and/or the ignition lock of the vehicle.

Opening or closing the door, the flap, the window or the other opening of the vehicle may for example be initiated by operating an operating device, for example a door handle of the vehicle, using a remote control, for example using a radio key of the vehicle and/or using the mobile terminal device. Operating the locking device may include unlocking or locking the locking device. For example, for unlocking or locking the locking device a vehicle key is introduced into a door lock of the vehicle and/or unlocking or locking the locking device is initiated using the remote control of the vehicle and/or using the mobile terminal device. Further, operating the ignition lock may include turning a vehicle key introduced into the ignition lock, for example for starting the motor of the vehicle and/or operating the ignition lock may be done using the remote control of the vehicle and/or using the mobile terminal device. Further, operating the ignition lock may include pressing a start/stop button of the vehicle for starting or stopping the motor of the vehicle and/or operating the starter device may be done using the remote control of the vehicle and/or using the mobile terminal device.

Providing the several evaluation signals which are changeable by a change of position of the mobile terminal device may include detecting several signals which are changeable by a change of position of the mobile terminal device. Detecting the several signals which are changeable by a change of position of the mobile terminal device may be done by the vehicle or by the mobile terminal device. If one or several signals which are changeable by a change of position of the mobile terminal device are detected by the vehicle, an evaluation of the signals may be done directly after signal provisioning. Preferably, the vehicle comprises one or several sensor units configured to detect one or several signals which are changeable by a change of position of the mobile terminal device. The one or several sensor units are preferably connected to an evaluation device of the vehicle in a signal-conducting way, wherein the evaluation device is configured to evaluate the several provided evaluation signals for detecting the relative position of the mobile terminal device with respect to the vehicle. For detecting one or several signals which are changeable by a change of position of the mobile terminal device, the mobile terminal device may include one or several sensor units which are configured to detect one or several signals which are changeable by a change of position of the mobile terminal device. As regularly not the detected signal but characteristics of the detected signal, like e.g. the signal strength and/or the signal quality are relevant for detecting the relative position of the mobile terminal device with respect to the vehicle, the method may include the step of generating the several evaluation signals which are changeable by a change of position of the mobile terminal device from the several detected signals which are changeable by a change of position of the mobile terminal device. So that the evaluation signals generated by the mobile terminal device may be evaluated by the vehicle, the method may include the step of transmitting the one or several generated evaluation signals which are changeable by a change of position of the mobile terminal device from the mobile terminal device to the vehicle. For this purpose, the mobile terminal device and the vehicle preferably each comprise a communication device, like for example the wireless communication interface, by means of which the provided signal values may be transmitted.

In some embodiments, the generated evaluation signals are buffered in a ring buffer. Further, only signal data of a selected time period are buffered for evaluation. By storing the signal data in the ring buffer, the advantage may be achieved that a size of a memory used for buffering the signal data may be reduced. Thus, the method may be executed more cost-effectively. The signal data may be evaluation signals and/or detected signals. For example, in the ring buffer data may be stored continuously for a predetermined time period. Further, after a predetermined time has elapsed, the stored data may be overwritten to make the memory area occupied by data stored in the ring buffer free again for new data. For example, in the ring buffer signal data of the last 15 seconds, the last 30 seconds, the last minute, the last 5 minutes or the last 15 minutes is stored.

Generating the several evaluation signals which are changeable by a change of position of the mobile terminal device from the several detected signals which are changeable by a change of position of the mobile terminal device may include measuring the signal strength of one or several detected signals which are changeable by a change of position of the mobile terminal device. The signal strength changes with the distance between the transmitter and the receiver. The evaluation of the signal strength of a communication signal between the vehicle and the mobile terminal device is for example especially suitable to detect the relative position of the mobile terminal device with respect to the vehicle. For evaluating a signal development, the temporal change of one or several detected signals which are changeable by a change of position of the mobile terminal device may be detected. Generating the several evaluation signals which are changeable by a change of position of the mobile terminal device from the several detected signals which are changeable by a change of position of the mobile terminal device may further include storing the generated evaluation signals which are changeable by a change of position of the mobile terminal device preferable in a ring buffer wherein evaluating the several provided evaluation signals is preferably initiated by determining an event. Often the evaluation of signal data is necessary which were detected before the initiating event so that the method preferably also includes storing one or several evaluation signals. Preferably, storing the evaluation signals is buffering in a ring buffer wherein only signal data of a selected time period are buffered for evaluation. The time period preferably extends from a first time instant before operating a locking device of the vehicle up to a second time instant after operating the locking device of the vehicle.

The several detected signals which are changeable by a change of position of position of the mobile terminal device may include a radio signal of a communication connection between the mobile terminal device and the vehicle and/or a mobile radio signal of the mobile terminal device. The radio signal may, for example, be a bluetooth signal or a WLAN (Wireless Local Area Network) signal. The method may include detecting the field strength change if the bluetooth radio path between the mobile terminal device and the vehicle and/or detecting the field strength change of the WLAN signal. The field strength of the Bluetooth signal directly reacts to a change of distance between the transmitter and the receiver and is thus especially suitable for detecting the relative position of the mobile terminal device with respect to the vehicle. By detecting the change of the field strength of the mobile radio signal of the mobile terminal device it may be derived whether the mobile terminal device has left the vehicle as the vehicle cover causes a field shielding and thus a field change. Alternatively or additionally, also other signal parameters may be evaluated. The mobile radio signal may, for example, be a GSM (Global System for Mobile Communications) signal, a UMTS (Universal Mobile Telecommunications System) signal or an LTE (Long Term Evolution) signal. The signal is preferably detected by a baseband transceiver of the mobile terminal device.

The several detected signals changeable by a change of position of the mobile terminal device may include a signal suitable for locating the mobile terminal device by means of a global navigation satellite system. By detecting the change of the navigation signal it may be derived whether the mobile terminal device has left the vehicle as the vehicle cover causes a field shielding and thus a field change. For example, the number of satellites found, their signal strengths and/or other signal parameters may be evaluated. The signal suitable for locating the mobile terminal device by means of a global navigation satellite system may be a GPRS (General Packet Radio Service) signal. The global navigation satellite system may be the NAVSTAR GPS satellite system, the GLONASS satellite system, the Galileo satellite system or the Beidou satellite system. The signal is preferably detected by a navigation satellite transceiver of the mobile terminal device.

The several detected signals changeable by a change of position of the mobile terminal device may include a signal measured by the mobile terminal device and depending on the earth's magnetic field. The signal is preferably detected by a magnetic field sensor of the mobile terminal device. By detecting the change of the magnetic field it may be derived whether the mobile terminal device has left the vehicle as the vehicle cover causes a field shielding and thus a field change. When evaluating the several provided evaluation signals for detecting the relative position of the mobile terminal device with respect to the vehicle the signal values between opening a door of the vehicle and closing or locking the door of the vehicle may be considered. In this time period, the mobile terminal device would be moved by the user when leaving the vehicle if the user did not leave it in the vehicle. An evaluation of the evaluation signals during this time period is thus especially suitable.

The method may include detecting a movement of the mobile terminal device preferably by means of an acceleration sensor of the mobile terminal device. The several provided evaluation signals which are changeable by a change of position of the mobile terminal device may include a signal relating to the movement of the mobile terminal device. By a detection of the change of the acceleration measurement values a movement of the mobile terminal device may be determined so that it may be derived whether the mobile terminal device has left the vehicle. Alternatively or additionally, also other movement patterns or directional vectors may be evaluated. Evaluating the several provided evaluation signals here preferably includes identifying a rest position of the mobile terminal device. A motionlessness and/or unchanged position of the mobile terminal device defined with a very tight tolerance is a very strong indicator that the mobile device is in the vehicle and not in the trouser or jacket pocket of a user. This approach may further in a very similar way be used for the moment of the unlocking request so that the protection from relay attacks is increased. If it is detected that the mobile terminal device is not moving an unlocking of the vehicle may be prevented.

Further, one or several evaluation signals may be provided which are changeable by a change of position of the vehicle. The one or several provided evaluation signals which are changeable by a change of position of the vehicle may be evaluated in addition to the several provided evaluation signals which are changeable by a change of position of the mobile terminal device for detecting the relative position of the mobile terminal device with respect to the vehicle. In particular in situations in which the vehicle moves during the locking process, such as on a ferry or in a cargo, a misinterpretation of the evaluation signals may result which are changeable by a change of position of the mobile terminal device. For reducing the risk of such a misinterpretation one or several evaluation signals may be considered in detecting the relative position of the mobile terminal with respect to the vehicle which are changeable by a change of position of the vehicle. By a corresponding signal comparison it may be detected whether a change of position of the mobile terminal device was caused by a change of position of the vehicle.

Providing the one or several evaluation signals which are changeable by a change of position of the vehicle may include detecting one or several signals which are changeable by a change of position of the vehicle, and generating one or several evaluation signals from the one or the several detected signals which are changeable by a change of position of the vehicle. The method may further include the step of detecting a movement of the vehicle, wherein detecting the movement of the vehicle is preferably executed by means of an acceleration sensor of the vehicle. The one or several provided evaluation signals which are changeable by a change of position of the vehicle may include a signal relating to the movement of the vehicle. Movements of the mobile terminal device caused by the vehicle's own movements may thus be detected reliably and erroneous statements on the rest position of the mobile device in the vehicle may be eliminated.

Generating the one or several evaluation signals which are changeable by a change of position of the vehicle from the one or several detected signals which are changeable by a change of position of the vehicle may include measuring the signal strength of one or several detected signals which are changeable by a change of position of the vehicle. The evaluation of the signal strength of a communication signal between the vehicle and the mobile terminal device is for example especially suitable to detect the relative position of the mobile terminal device with respect to the vehicle. For evaluating a signal development, the temporal change of one or several detected signals which are changeable by a change of position of the vehicle may be detected. In particular when evaluating a signal of a navigation satellite system also the number of located satellites may be considered. Further, apart from the signal strength also other transmission parameters may be measured or sensed, like for example the error rate in signal transmission.

Evaluating the several provided evaluation signals may include comparing the temporal change of the acceleration amplitude of the mobile terminal device and the vehicle. By comparing the changes of the acceleration amplitude of the mobile terminal device and the vehicle it may be determined whether the mobile terminal device has been accelerated by the vehicle's own movement which has been transferred to the mobile terminal device. By comparing the changes of the acceleration amplitude of the mobile terminal device and the vehicle misinterpretations may thus be prevented with an even higher reliability. Alternatively or additionally, evaluating the several provided evaluation signals may include comparing movement profiles of the mobile terminal device and the vehicle. By comparing movement profiles of the mobile terminal device and the vehicle information on the position of the mobile terminal device in the vehicle may be gained. Further, a quantification of the signals underlying the movement profiles may be executed e.g. by cross-correlation or Fast Fourier Transform (FFT). The vehicle's own movements may for example be intentionally generated by actuators within the vehicle to enable a localization of the mobile terminal device within the vehicle. The actuators within the vehicle may include actuators of a seat adjustment device, actuators of a steering assistance, one or several vehicle-integrated electric motors or one or several unbalance actuators. Alternatively or additionally, evaluating the several provided evaluation signals may include detecting a time instant at which a door of the vehicle is closed and/or comparing acceleration profiles of the mobile terminal device and the vehicle. The acceleration profiles of the mobile terminal device and the vehicle preferably include acceleration information of the mobile terminal device and the vehicle from a time period in which also the time instant is located at which the door of the vehicle is closed. By comparing acceleration profiles of the mobile terminal device and the vehicle during the closing process of the door it may be detected whether the mobile terminal device is in contact with the vehicle. If the closing process of the door may be derived from the acceleration information of the mobile terminal device, this is a strong indicator that the mobile terminal device is within the vehicle and not outside the vehicle at the body of the driver.

The several detected signals changeable by a change of position of the mobile terminal device may include an acoustic signal recorded and thus generated by the mobile terminal device using a microphone. Alternatively or additionally, the several detected signals changeable by a change of position of the mobile terminal device include an acoustic signal recorded and thus generated by the vehicle using a microphone. The acoustic signals may be evaluated regarding characteristic noises which allows a conclusion whether the mobile terminal device is still within the vehicle. Apart from that, an acoustic signal detected by the mobile terminal device may be compared to acoustic signals detected by the vehicle, to acquire further information on the relative position of the mobile terminal device with respect to the vehicle. Additionally the mobile terminal device and/or the vehicle may themselves generate and emit sound waves which may be recorded again as an acoustic signal.

Further, vibrations may be generated by the mobile terminal device. Alternatively or additionally, vibrations may be generated by the vehicle. For generating vibrations, the mobile terminal device and/or the vehicle may for example include a vibration generator. The several detected signals changeable by a change of position of the mobile terminal device may include a vibration signal generated by the mobile terminal device. Moreover, the several detected signals changeable by a change of position of the mobile terminal device may include a vibration signal generated by the vehicle. A vibration signal detected by the mobile terminal device may be compared to vibration signals detected by the vehicle, to acquire further information on the relative position of the mobile terminal device with respect to the vehicle.

Evaluating the several provided evaluation signals may include determining whether the mobile terminal device is within the vehicle and/or determining whether the mobile terminal device is outside the vehicle. Finally, a vehicle access system which prevents closing in a mobile terminal device within the vehicle needs information whether the mobile terminal device is in the interior of the vehicle at the time of locking. By detecting this information the method is suitable for being used with a corresponding vehicle access system.

According to a second aspect, embodiments provide a method for detecting a relative position of a mobile terminal device with respect to a vehicle. In the inventive method of detecting the relative position of the mobile terminal with respect to the vehicle several evaluation signals are provided changeable by a change of position of the mobile terminal device, wherein the several provided evaluation signals for detecting the relative position of the mobile terminal device are evaluated with respect to the vehicle. Evaluating the several provided evaluation signals may be done by the vehicle and/or the mobile terminal device. The same advantages and modifications as described hereinabove apply.

According to a third aspect, embodiments provide a system for detecting a relative position of a mobile terminal device with respect to a vehicle. The inventive system for detecting the relative position of the mobile terminal device with respect to the vehicle includes a mobile terminal device and a vehicle. The system is configured to execute the method of detecting a relative position of a mobile terminal device with respect to a vehicle according to any of the above described embodiments described in connection with the first aspect and/or the second aspect. The same advantages and modifications as described hereinabove apply. The vehicle and/or the mobile terminal device may include an evaluation device.

Further preferred embodiments of the invention result from the remaining features mentioned in the dependent claims.

The different embodiments of the invention mentioned in this application may, as far as not indicated otherwise, combined advantageously.

The invention is hereinafter explained in embodiments using the associated drawings, in which:

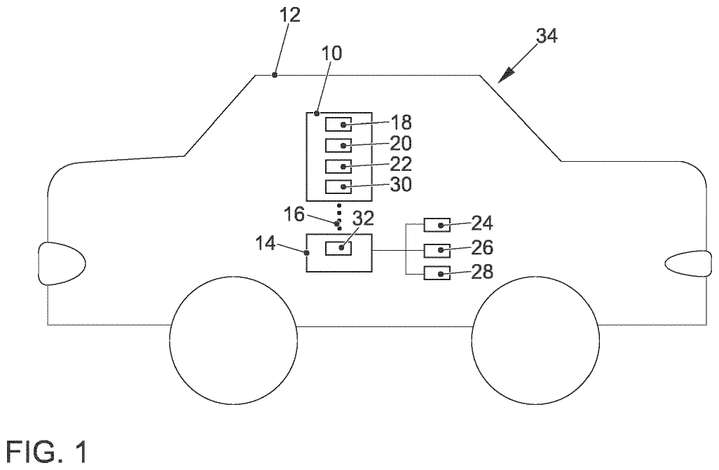

FIG. 1 shows a schematic illustration of an inventive system for detecting a relative position of a mobile terminal device with respect to a vehicle;

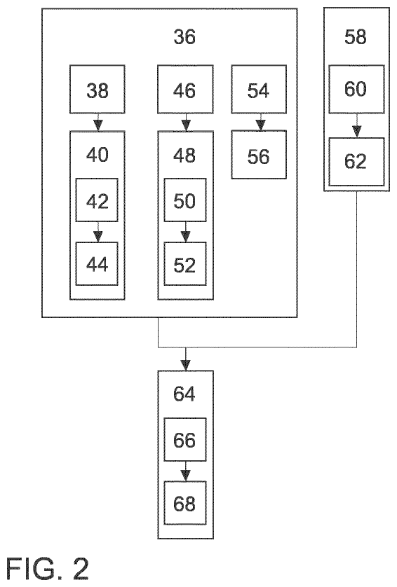

FIG. 2 shows a flow chart of an inventive method for detecting a relative position of a mobile terminal device with respect to a vehicle according to one embodiment; and

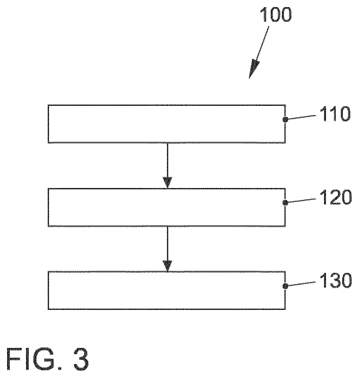

FIG. 3 shows a flow chart of an inventive method for detecting a relative position of a mobile terminal device with respect to a vehicle according to a further embodiment.

FIG. 1 shows a system 34 with a mobile terminal device 10 and a vehicle 12. The mobile terminal device 10 is configured as a smartphone and includes three sensor units 18-22 and one communication device 30. The vehicle 10 comprises a signal evaluation device 14 and three sensor units 24-28 connected in a signal conducting way to the signal evaluation device 14.

The signal evaluation device 14 of the vehicle 12 includes a communication device 32 which is connected to the communication device 30 of the mobile terminal device 10 by a signal conducting connection 16.

The first sensor unit 18 of the mobile terminal device 10 is configured as a radio signal sensor and is implemented to detect the signal strength of the mobile radio signal of the mobile terminal device 10. The mobile terminal device 10 is further configured to generate an evaluation signal from the signal strength of its own mobile radio signal and provide this evaluation signal to the evaluation device 14 of the vehicle 12 by means of the communication device 30. The second sensor unit 20 of the mobile terminal device 10 is configured as a magnetic field sensor and implemented to generate a signal depending on the earth's magnetic field and provide this magnetic field signal to the evaluation device 20 of the vehicle 12 as an evaluation signal. Providing this evaluation signal is again done by the communication devices 30, 32 of the mobile terminal device and the vehicle. The third sensor unit 22 of the mobile terminal device 10 is configured as an acceleration sensor and is implemented to detect the movements of the mobile terminal device 10. The signal generated by the acceleration sensor is provided to the evaluation device 20 of the vehicle also by means of the communication devices 30, 32 of the mobile terminal device and the vehicle as an evaluation signal.

The first sensor unit 24 of the vehicle 12 is configured as a radio signal sensor and is implemented to detect the signal strength and other parameters of the radio signal of the communication connection 16 between the mobile terminal device 10 and the vehicle 12. The radio signal sensor may further be configured to detect a GPS signal, a 5G signal, a WLAN signal or a BTLE signal. The evaluation signal is generated on the basis of the detected signal strength and/or the other detected parameters of the radio signal of the communication connection 16 between the mobile terminal device 10 and the vehicle 12 and provided to the evaluation device 14. The second sensor unit 26 of the vehicle 12 is configured as a magnetic field sensor and implemented to generate a signal depending on the earth's magnetic field and provide this magnetic field signal to the evaluation device 14. The third sensor unit 28 of the vehicle 12 is configured as an acceleration sensor and is implemented to detect the movements of the vehicle 12. The signal generated by the acceleration sensor is also provided to the evaluation device 14 as an evaluation signal.

The evaluation device 14 is configured to evaluate the overall six provided evaluation signals for detecting the relative position of the mobile terminal device 10 with respect to the vehicle 12. In this respect, the temporal change of the signal strength of the mobile radio signal of the mobile terminal device 10 and the temporal change of the signal strength of the radio signal of the communication connection 16 between the mobile terminal device 10 and the vehicle 12 between opening a door of the vehicle 12 and closing the door of the vehicle 12 is evaluated. Moreover, the temporal change of the signal depending on the earth's magnetic field provided by the mobile terminal device 10 and the temporal change of the signal depending on the earth's magnetic field provided by the vehicle 12 is evaluated. Further, the movement of the mobile terminal device 10 is evaluated by the evaluation device 14 and the movement of the mobile terminal device 10 is compared to the movement of the vehicle 12.

On the basis of the evaluation of the overall six provided evaluation signals, a comparatively secure determination may be made whether the mobile terminal device 10 has been left back in the vehicle 12 by the user when leaving the vehicle 12.

FIG. 2 shows a method for detecting a relative position of a mobile terminal device 10 with respect to a vehicle 12, according to one embodiment. The method is based on the evaluation of several evaluation signals so that a comparatively reliable determination may be made as to whether the mobile terminal device 10 is inside or outside the vehicle 12. The method starts with the following step:

36) Providing three evaluation signals which are changeable by a change of position of the mobile terminal device 10.

The three provided evaluation signals relate to the signal strength of the radio network of the mobile terminal device 10, to the signal strength of the bluetooth connection between the mobile terminal device 10 and the vehicle 12 and the movement of the mobile terminal device 10. For providing the evaluation signal relating to the signal strength of the radio network of the mobile terminal device 10 providing the three evaluation signals changeable by a change of position of the mobile terminal device 10 comprises the following step:

38) Detecting the mobile radio signal of the mobile terminal device 10.

As for detecting the relative position of the mobile terminal device 10 with respect to the vehicle 12 not the mobile radio signal of the mobile terminal device 10 as such but the temporal change of the signal strength of the mobile radio signal or the temporal change of other parameters of the mobile radio signal is to be used, after detecting of the mobile radio signal of the mobile terminal device 10 the following step follows:

40) Generating an evaluation signal from the detected mobile radio signal of the mobile terminal device 10.

Generating an evaluation signal from the detected mobile radio signal of the mobile terminal device 10 here includes the following two steps:

42) Measuring the signal strength the mobile radio signal of the mobile terminal device 10; and

44) Detecting the temporal change of the signal strength the mobile radio signal of the mobile terminal device 10.

For providing the evaluation signal relating to the signal strength of the bluetooth connection between the mobile terminal device 10 and the vehicle 12 providing the three evaluation signals changeable by a change of position of the mobile terminal device 10 comprises the following step:

46) Detecting the bluetooth connection signal between the mobile terminal device 10 and the vehicle 12.

As for detecting the relative position of the mobile terminal device 10 with respect to the vehicle 12 not the bluetooth connection signal between the mobile terminal device 10 and the vehicle 12 as such but the temporal change of the signal strength of the bluetooth connection signal between the mobile terminal device 10 and the vehicle 12 is to be used, after detecting of the bluetooth connection signal between the mobile terminal device 10 and the vehicle 12 the following step follows:

48) Generating an evaluation signal from the detected bluetooth connection signal between the mobile terminal device 10 and the vehicle 12.

Generating an evaluation signal from the detected bluetooth connection signal between the mobile terminal device 10 and the vehicle 12 here includes the following steps:

50) Measuring the signal strength of the bluetooth connection signal between the mobile terminal device 10 and the vehicle 12; and

52) Detecting the temporal change of the signal strength of the bluetooth connection signal between the mobile terminal device 10 and the vehicle 12.

For providing the evaluation signal relating to the movement of the mobile terminal device 10, providing the three evaluation signals changeable by a change of position of the mobile terminal device 10 comprises the following steps:

54) Detecting a movement of the mobile terminal device 10 by means of an acceleration sensor 18 of the mobile terminal device 10; and

56) Generating an evaluation signal from the detected movement of the mobile terminal device 10.

The method considers not only three evaluation signals changeable by a change of position of the mobile terminal device 10 but also an evaluation signal changeable by a change of position of the vehicle 12. The method consequently includes the following step:

58) Providing an evaluation signal changeable by a change of position of the vehicle 12.

The provided evaluation signal relates to the movement of the vehicle 12. For providing the evaluation signal relating to the movement of vehicle 12, providing the one evaluation signal changeable by a change of position of the vehicle 12 comprises the following steps:

60) Detecting a movement of the vehicle 12 by means of an acceleration sensor 24 of the vehicle 12; and

62) Generating an evaluation signal from the detected movement of the vehicle 12.

After the required evaluation signals have been provided, the following step is executed:

64) Evaluating the several provided evaluation signals by the vehicle 12 for detecting the relative position of the mobile terminal device 10 with respect to the vehicle 12.

Apart from evaluating the temporal change of the signal strength of the mobile radio signal of the mobile terminal device 10 and the temporal change of the signal strength of the bluetooth connection signal between the mobile terminal device 10 and the vehicle 12, evaluating the several provided evaluation signals comprises the following step:

66) Comparing the temporal change of the acceleration amplitude of the mobile terminal device 10 and the vehicle 12.

Evaluating the several provided evaluation signals by the vehicle 12 for detecting the relative position of the mobile terminal device 10 with respect to the vehicle 12 is completed with the following step:

68) Determining, whether the mobile terminal device 10 is in the vehicle 12.

By considering several evaluation signals for detecting the relative position of the mobile terminal device 10 with respect to the vehicle, the inventive method enables a reliable determination as to whether the mobile terminal device 10 has been left back in the vehicle 12 by the user when leaving the vehicle 12.

FIG. 3 shows a flow chart of the inventive method 100 for detecting a relative position of the mobile terminal device 10 with respect to the vehicle 12 according to a further embodiment. The method 100 includes providing 110 several evaluation signals. The several evaluation signals are each changed by a change of position of the mobile terminal device 10. Further, the method 100 includes determining 120 an event at the vehicle 12. The method 100 further comprises evaluating 130 the several provided evaluation signals for detecting the relative position of the mobile terminal device 10 with respect to the vehicle 12 in response to determining 120 the event at the vehicle 12.

The mobile terminal device 10 may be a mobile phone, a smart phone, a smart watch, a tablet computer, a laptop, a mobile device or a car key. Further, the vehicle 12 may be a land vehicle, like a passenger vehicle, a commercial vehicle or a motorcycle, a rail vehicle, like a train or a tram, an aircraft, like a helicopter or an airplane or a watercraft like a ship or a boat. Further, the mobile terminal device 10 and the vehicle 12 may be configured to communicate via a wireless communication network. In this respect, the mobile terminal device 10 and the vehicle may 12 may each comprise a wireless communication interface configured to communicate via the wireless communication network. For example, the wireless communication network may be a bluetooth communication network, a bluetooth-low-energy communication network, a near field communication network, a Wireless Local Area Network (WLAN) communication network, an ultra wideband (UWB) communication network or a mobile radio network. Further, providing may be executed by means of one or several sensor units 18-20 and/or evaluating 130 may be executed by means of the signal evaluation device 14.

The method 100 of detecting of the relative position of the mobile terminal device 10 with respect to the vehicle 12 may be executed in a plurality of situations. For example, the method 100 is executed to determine whether a user, like e.g. a driver or a passenger of the vehicle 12 has left back the mobile terminal device 10 in the vehicle 12 when leaving the vehicle 12 or not. If the user has left the mobile terminal device in the vehicle 12, this may be indicated to the user by means of a signal tone or an optical display element. For example, the signal tone is output via a loudspeaker of the mobile terminal device 10 or a loudspeaker of the vehicle 12.

Further, the method 100 may be executed when the vehicle 12 starts driving or when the motor of the vehicle 12 is started in order to determine whether the mobile terminal device 10 is in the vehicle 12. If the mobile terminal device 10 is outside the vehicle 12 when the vehicle 12 starts driving or when the motor of the vehicle 12 is started, for example on a roof of the vehicle 12 or on a windshield of the vehicle 12, this may be indicated to the user by means of a signal tone or an optical display element. For example, for this purpose a warning light lights up in the dashboard of the vehicle 12.

In some embodiments, providing the several evaluation signals includes detecting several signals of a navigation satellite system, like the NAVSTAR GPS satellite system, the GLONASS satellite system, the Galileo satellite system or the Beidou satellite system, by the mobile terminal device 10 or a navigation satellite transceiver of the mobile terminal device 10 at different time instants. The mobile terminal device 10 may detect and store the signals continuously, like e.g. at intervals of several seconds. Preferably, the mobile terminal device 10 stores the signals in a ring buffer. If now an event is detected at the vehicle 12, like e.g. a closing or locking of a door of the vehicle 12, on the basis of the stored signals the relative position of the mobile terminal device 10 with respect to the vehicle 12 may be detected. In this respect, for example a number of navigation satellites found in the respective signal, their signal strength and/or other signal parameters of same at a certain time instant, for example just before opening the door of the vehicle 12, is compared to the corresponding values after this certain time instant, for example just before or just after closing the door of the vehicle 12. As the vehicle cover of the vehicle 12 causes a shielding or field change of the signals of the navigation satellite system, it may be concluded by this comparison, whether the mobile terminal device 10 is inside or outside the vehicle 12 after the event. If, for example, the number of found navigation satellites or their signal strengths after closing the door of the vehicle 12 is higher than before opening the door, it may be concluded that the mobile terminal device 10 has left the vehicle 12. If, however, the number of found navigation satellites or their signal strengths after closing the door of the vehicle 12 is lower than before opening the door, it may be concluded that the mobile terminal device 10 has entered the vehicle 12. If the number of navigation satellites found or their signal strengths before opening the door of the vehicle 12 corresponds to the number of navigation satellites found or their signal strengths after closing the door of the vehicle 12, it may be concluded that the mobile terminal device 10 has not changed its relative position with respect to the vehicle 12. The mobile terminal device 10 may in this case either be outside or inside the vehicle 12. This may be indicated to a user of the vehicle 12 as described above. For the comparison the last signal detected before opening the door may be compared to the first signal detected after opening or closing the door. Alternatively or additionally, average values of signals detected before and after opening the door, for example of 3, 5 or 10 detected signals or values derived therefrom may be compared. Here, optionally the respectively detected minimum values and/or maximum values may be discarded.

In some embodiments, providing 110 the several evaluation signals includes detecting several signals of a mobile radio system, like telephone network signals of a GSM, UMTS or LTE mobile radio system, by the mobile terminal device 10 or a baseband transceiver of the mobile terminal device 10 at different time instants. The mobile terminal device 10 may detect and store the signals continuously, like e.g. at intervals of several seconds. Preferably, the mobile terminal device 10 stores the signals in a ring buffer. If now an event is detected at the vehicle 12, like e.g. a closing or locking of a door of the vehicle 12, on the basis of the stored signals the relative position of the mobile terminal device 10 with respect to the vehicle 12 may be detected. In this respect, for example a kind of telephone band found in the respective signal, its signal strength and/or other signal parameters of the respective signal at a certain time instant, for example just before opening the door of the vehicle 12, is compared to the corresponding values after this certain time instant, for example just before or just after closing the door of the vehicle 12. As the vehicle cover of the vehicle 12 causes a shielding or field change of the signals of the mobile radio system, it may be concluded from this comparison, whether the mobile terminal device 10 is inside or outside the vehicle 12 after the event. If, for example, the signal strength of the detected signals after closing the door of the vehicle 12 is higher than before opening the door, it may be concluded that the mobile terminal device 10 has left the vehicle 12. If, however, the signal strength of the detected signals after closing the door of the vehicle 12 is lower than before opening the door, if may be concluded that the mobile terminal device 10 has entered the vehicle 12. If the signal strength of the detected signals before opening the door of the vehicle 12 corresponds to the signal strength of the detected signals after closing the door of the vehicle 12, it may be concluded that the mobile terminal device 10 has not changed its relative position with respect to the vehicle 12. The mobile terminal device 10 may in this case either be outside or inside the vehicle 12. This may be indicated to a user of the vehicle 12 as described above. For the comparison the last signal detected before opening the door may be compared to the first signal detected after opening or closing the door. Alternatively or additionally, average values of signals detected before and after opening the door, for example of 3, 5 or 10 detected signals or values derived therefrom may be compared. Here, optionally the respectively detected minimum values and/or maximum values may be discarded.

In some embodiments, providing 110 the several evaluation signals includes detecting the field strength of the earth's magnetic field acting upon the mobile terminal device 10 by the mobile terminal device 10 or a magnetic field sensor of the mobile terminal device 10 at different time instants. The mobile terminal device 10 may detect and store the field strength continuously, like e.g. at intervals of several seconds. Preferably, the mobile terminal device 10 stores the field strengths in a ring buffer. If now an event is detected at the vehicle 12, like e.g. a closing or locking of a door of the vehicle 12, on the basis of the stored field strengths the relative position of the mobile terminal device 10 with respect to the vehicle 12 may be detected. In this respect, for example the field strength at a certain time instant, for example just before opening the door of the vehicle 12, is compared to the field strength after this certain time instant, for example just before or just after closing the door of the vehicle 12. As the vehicle cover of the vehicle 12 causes a shielding of the earth's magnetic field, it may be concluded from this comparison, whether the mobile terminal device 10 is inside or outside the vehicle 12 after the event. If, for example, the field strength after closing the door of the vehicle 12 is higher than before opening the door, it may be concluded that the mobile terminal device 10 has left the vehicle 12. If, however, the field strength after closing the door of the vehicle 12 is lower than before opening the door, it may be concluded that the mobile terminal device 10 has entered the vehicle 12. If, however, the field strength before opening the door of the vehicle 12 corresponds to the field strength after closing the door of the vehicle 12, it may be concluded that the mobile terminal device 10 has not changed its relative position with respect to the vehicle 12. The mobile terminal device 10 may in this case either be outside or inside the vehicle 12. This may be indicated to a user of the vehicle 12 as described above. For the comparison the last field strength detected before opening the door may be compared to the first field strength detected after opening or closing the door. Alternatively or additionally, average values of field strengths detected before and after opening the door, for example of 3, 5 or 10 detected field strengths may be compared. Here, optionally the respectively detected minimum values and/or maximum values may be discarded.

In some embodiments, providing 110 the several evaluation signals includes detecting a movement of the mobile terminal device 10 by means of an acceleration sensor of the mobile terminal device 10 and detecting a movement of the vehicle 12 by means of an acceleration sensor of the vehicle 12. For example, the movement of the vehicle 12 is a movement of the vehicle 12 caused by a person entering or exiting, a movement of the vehicle 12 caused by a slamming shut of the door of the vehicle 12 or a movement of the vehicle 12 caused by any other vibration of the vehicle 12, for example vibration caused by an electric motor of the vehicle 12. Here, evaluating 130 the provided evaluation signals may include comparing movement frequencies or vibration frequencies of the detected movement of the mobile terminal device 10 and the detected movement of the vehicle 12. If the movement frequencies or vibration frequencies correspond, it may be concluded that the mobile terminal device 10 is in the vehicle 12. Otherwise, the mobile terminal device 10 may be outside the vehicle 12. Further, evaluating 130 the provided evaluation signals may include comparing movement patterns or vibration patterns of the detected movement of the mobile terminal device 10 and the detected movement of the vehicle 12. If the movement patterns or vibration patterns correspond, it may be concluded that the mobile terminal device 10 is in the vehicle 12. Otherwise, the mobile terminal device 10 is outside the vehicle 12.

In some embodiments, by means of the method 100 a method based on evidence and/or indicators for detecting mobile terminal devices 10 like, for example, smartphones may be provided inside and outside vehicles 12.

In some embodiments, indicators on the position, for example inside or outside the vehicle 12, of the mobile terminal device 10 may be derived using one or several sensors 18-28 in the vehicle using different evaluation strategies of the measurement values. Using several such different measurement value evaluation strategies a sufficiently exact statement may be enabled on whether the mobile terminal device 10 is inside or outside the vehicle 12. For example, with different results of the evaluation strategies, for the position of the mobile terminal device 10 the one position is selected which was determined by the plurality of evaluation strategies. Further, different weighting factors may be allocated to the different evaluation strategies. If a first number of evaluation strategies results in a first position of the mobile terminal device 10 and a second number of evaluation strategies results in a second position of the mobile terminal device 10, for example a first sum is formed from the weighting factors of the first number of evaluation strategies and a second sum is formed from the weighting factors of the second number of evaluation strategies. If the first sum is greater than the second sum, the mobile terminal device 10 may be located in the first position. Otherwise, the mobile terminal device 10 may be in the second position. Further, a detection of inside/outside may be improved or supported by exclusion criteria. For this purpose, an especially high weighting factor is allocated to at least one evaluation strategy.

In some embodiments, the evaluation strategies may be strengthened regarding their significance in a concrete context of events or trigger events. Respective event triggers may be exchanged between mobile terminal device 10 and vehicle 12 uni- or bi-directionally via radio frequency communication, for example via the wireless communication network and thus measurement value evaluations may be brought in temporal context with the events.

In some embodiments one of the evaluation strategies may be the measurement of the changes of the quality of a navigation signal, for example a GPS, Galileo or Glonass navigation signal using the navigation satellite transceiver of the mobile terminal device 10 between opening the door and closing/locking the same in order to derive an indicator therefrom whether the mobile terminal device 10 has left the vehicle 12. Here, for example, field shielding or field change is utilized by the vehicle cover. Further, for example, here the number of satellites found, their signal strengths and/or other signal parameters are evaluated.

In some embodiments, one of the evaluation strategies may include measuring the changes of the quality of the telephone network signal, for example a Global System for Mobile Communications (GSM) telephone network signal, a Universal Mobile Telecommunications System (UMTS) telephone network signal, a Long Term Evolution (LTE) telephone network signal, a Long Term Evolution Advanced (LTE-A) telephone network signal using the baseband transceiver of the mobile terminal device 10 between opening the door and closing/locking the same in order to derive an indicator therefrom whether the mobile terminal device 10 has left the vehicle 12. Here, field shielding or field change may be utilized by the vehicle cover. For example, here the kind of telephone band found, its signal strength and/or other signal parameters are evaluated.

In some embodiments, one of the evaluation strategies may be the measurement of the changes of the earth's magnetic field with the magnetic field sensor of the mobile terminal device 10 between opening the door of the vehicle 12 and closing/locking the same in order to derive an indicator therefrom whether the mobile terminal device 10 has left the vehicle 12. Here, field shielding or field change may be utilized by the vehicle cover of the vehicle.

In some embodiments, one of the evaluation strategies may be the measurement of the changes of the acceleration measurement values with the acceleration sensor of the mobile terminal device 10 between opening the door of the vehicle 12 and closing/locking the same in order to derive therefrom whether the mobile terminal device 10 has left the vehicle 12, for example by characteristic movement patterns, directional vectors or other variables regarding movement characteristics.

In some embodiments, one of the evaluation strategies may include the measurement of the acceleration measurement values using the acceleration sensor of the mobile terminal device 10 during a time window around the moment of detecting the locking attempt, for example when an operation of the lock button or key at the door handle of the vehicle 12 or a system has been detected. For example, the acceleration measurement values are measured from one second before the moment of detecting the locking attempt until one second thereafter. As this moment triggered or caused by the user at any time is not known to the mobile terminal device 10 in advance, the same may store the acceleration measurement values for example in a ring buffer which buffers for few seconds so that in retrospect all data necessary for an evaluation are available. The evaluation may examine the measurement data in particular with respect to a rest position of the mobile terminal device 10. A motionlessness and/or unchanged position of the mobile terminal device defined with a very tight tolerance is a very strong indicator that the mobile device 10 is at this time instant still in the vehicle 12 and not in the trouser or jacket pocket of a user. This approach may additionally be used very similarly for the moment of the unlocking attempt which may directly additionally enable a large safety leap in the protection against relay attacks. When the mobile terminal device 10 is lying around motionless somewhere a hands-free system of the vehicle 12 may be protected from a relay attack, for example in an access and/or driving authorization request. Optionally, by parallel measurement of the movements of the mobile terminal device 10 with the acceleration sensor of the mobile terminal device 10 and the movements of the vehicle 12 with a vehicle-integrated acceleration sensor, from the similarity of the changes of the acceleration amplitude the indicator for the rest position of the mobile terminal device 10 relative to the vehicle 12 may be gained. Thus, incorrect statements on the rest position of the mobile terminal device 10 in the vehicle 12 caused by the vehicle's own movement may be eliminated. Optionally, also by parallel measurement of the movements of the mobile terminal device 10 with the acceleration sensor of the mobile terminal device 10 and the movements of the vehicle 12 with a vehicle-integrated acceleration sensor, from the similarity of the respective movement profiles, for example quantified by cross-correlation, fast Fourier Transform (FFT) etc., the indicator for the position of the mobile terminal device 10 in the vehicle 12 may be gained. The vehicle's own movements may possibly, if not already existing, be generated by a vehicle-integrated actuator technology, like a suitable, for example pulsating control of existing actuator technology, like for example the so-called “Power Seat”, the so-called “Power Steering”, an electric motor etc. or dedicated additional actuator technology, for example an unbalance actuator.

In some embodiments, a further evaluation strategy may be based on the simultaneous similarity or correlation of the measured acceleration profile of a parallel measurement with acceleration sensors in the mobile terminal device 10 and in the vehicle 12 at the time of slamming a door of the vehicle 12 shut, to derive therefrom, whether the mobile terminal device 10 is in mechanical contact with the vehicle 12, for example whether the mobile terminal device 10 is in the vehicle 12. This may be a strong indicator that the mobile terminal device 10 is still in the vehicle and not outside the vehicle 12 at the body of the driver. Here, as an actuator, finally the user or driver itself and no specially electrically driven actuator technology may be used.

In some embodiments, a further evaluation strategy may include the recording of noises with a microphone of the mobile terminal device 10 by analyzing the recorded noises with respect to whether characteristic noises exist as an indicator for leaving the vehicle 12. Here, for example, a comparison of the recorded noises with reference noises previously stored in the mobile terminal device 10 or in the vehicle 12 may be executed. Optionally, further using a parallel recording and evaluation of the noises with the mobile terminal device 10 and a microphone in the vehicle 12 indicators for the mobile terminal device 10 being located inside or outside the vehicle 12 may be gained. Here, the respectively recorded noises may be checked with respect to common frequencies or sound signals. Optionally, the vehicle 12 may further generate and/or emit sound waves used for the above evaluation.

In some embodiments, a further evaluation strategy may include the emission of sound waves by the mobile terminal device 10 at certain time instants which are recorded and evaluated by a microphone in the vehicle 12 for example after closing the doors and windows of the vehicle and/or before locking the vehicle 12. In this respect, for example a comparison of the recorded noises with the emitted sound waves for example regarding corresponding frequencies and/or tone sequences may be executed.

In some embodiments, a further evaluation strategy may include generating vibrations by a vibration of the mobile terminal device 10 at certain time instants which are evaluated by an acceleration sensor in the vehicle 12 in order to detect whether the mobile terminal device 10 is in the vehicle 12.

### REFERENCE NUMERALS LIST

10 mobile terminal device

12 vehicle

14 signal evaluation device

16 communication connection

18-22 sensor units of the mobile terminal device

24-28 sensor units of the vehicle

30 communication device

32 communication device

34 system

36-68 method steps

100 method

110 providing

120 determining

130 evaluating

1-15. (canceled)

16. A method for detecting a relative position of a mobile terminal device with respect to a vehicle, comprising:
providing several evaluation signals which are changed by a change of position of the mobile terminal device;
determining an event at the vehicle;
evaluating the several provided evaluation signals for detecting the relative position of the mobile terminal device with respect to the vehicle in response to determining the event at the vehicle.

17. The method according to claim 16, wherein the event at the vehicle is one of the following events:
opening or closing a door, a flap, a window or another opening of the vehicle;
operating a locking device of the vehicle;
operating an ignition lock of the vehicle; or
operating a starter device of the vehicle.

18. The method according to claim 16, wherein providing the several evaluation signals which are changeable by a change of position of the mobile terminal device comprises:
detecting several signals which are changeable by a change of position of the mobile terminal device; and
generating the several evaluation signals which are changeable by a change of position of the mobile terminal device from the several detected signals which are changeable by a change of position of the mobile terminal device.

19. The method according to claim 18, wherein the generated evaluation signals are buffered in a ring buffer and wherein only signal data of a selected time period is buffered for evaluation.

20. The method according to claim 18, wherein generating the several evaluation signals which are changeable by a change of position of the mobile terminal device from the several detected signals which are changeable by a change of position of the mobile terminal device includes at least one of the following steps:
measuring the signal strength of one or several detected signals which are changeable by a change of position of position of the mobile terminal device;
detecting the temporal change of one or several detected signals which are changeable by a change of position of the mobile terminal device.

21. The method according to claim 18, wherein the several detected signals which are changeable by a change of position of the mobile terminal device include a radio signal of a communication connection between the mobile terminal device and the vehicle and/or a mobile radio signal of the mobile terminal device.

22. The method according to claim 18, wherein the several detected signals which are changeable by a change of position of the mobile terminal device include a signal suitable for locating the mobile terminal device by means of a global navigation satellite system or a signal measured by the mobile terminal device and depending on the earth's magnetic field.

23. The method according to claim 16, further comprising:
detecting a movement of the mobile terminal device by means of an acceleration sensor of the mobile terminal device;
wherein the several provided evaluation signals which are changeable by a change of position of the mobile terminal device include a signal relating to the movement of the mobile terminal device.

24. The method according to claim 16, further comprising:
providing one or several evaluation signals changeable by a change of position of the vehicle.

25. The method according to claim 24, wherein providing the one or several evaluation signals which are changeable by a change of position of the vehicle comprises at least one of the following steps:
detecting one or several signals which are changeable by a change of position of the vehicle;
generating one or several evaluation signals which are changeable by a change of position of the vehicle from the one or several detected signals which are changeable by a change of position of the vehicle;
detecting a movement of the vehicle preferably by means of an acceleration sensor of the vehicle;
wherein the one or several provided evaluation signals which are changeable by a change of position of the vehicle include a signal relating to the movement of the vehicle.

26. The method according to claim 25, wherein generating the one or several evaluation signals which are changeable by a change of position of the vehicle from the one or several detected signals which are changeable by a change of position of the vehicle includes at least one of the following steps:
measuring the signal strength of one or several detected signals which are changeable by a change of position of position of the vehicle;
detecting the temporal change of one or several detected signals which are changeable by a change of position of the vehicle.

27. The method according to claim 16, wherein evaluating the several provided evaluation signals comprises one, several or any of the following steps:
comparing the temporal change of the acceleration amplitude of the mobile terminal device and the vehicle;
comparing movement profiles of the mobile terminal device and the vehicle;
detecting a time instant at which a door of the vehicle is closed;
comparing acceleration profiles of the mobile terminal device and the vehicle preferably including acceleration information of the mobile terminal device and the vehicle from a time period in which also the time instant is located at which the door of the vehicle was closed.

28. The method according to claim 16, wherein the several detected signals which are changeable by a change of position of the mobile terminal device include an acoustic signal recorded and thus generated by the mobile terminal device by means of a microphone, and/or an acoustic signal recorded and thus generated by the vehicle by means of a microphone.

29. The method according to claim 16, further comprising at least one of the following steps:
generating vibrations by the mobile terminal device;
generating vibrations by the vehicle;
wherein the several detected signals which are changeable by a change of position of the mobile terminal device include a vibration signal generated by the mobile terminal device and/or a vibration signal generated by the vehicle.

30. A system for detecting a relative position of a mobile terminal device with respect to a vehicle, comprising:
a mobile terminal device; and
a vehicle;
wherein the system is configured to execute a method of detecting a relative position of a mobile terminal device with respect to the vehicle, the method comprising:
providing several evaluation signals which are changed by a change of position of the mobile terminal device;
determining an event at the vehicle;
evaluating the several provided evaluation signals for detecting the relative position of the mobile terminal device with respect to the vehicle in response to determining the event at the vehicle.
